(19) United States
(12) Patent Application Publication
(10) Pub. No.: US 2013/0262202 A1
(43) Pub. Date: Oct. 3, 2013

(54) TRADE-IN OPTION LEVEL

(71) Applicants: Filippo Balestrieri, Mountain View, CA (US); Julie Ward Drew, Redwood City, CA (US)

(72) Inventors: Filippo Balestrieri, Mountain View, CA (US); Julie Ward Drew, Redwood City, CA (US)

(21) Appl. No.: 13/434,581

(22) Filed: Mar. 29, 2012

(51) Int. Cl. G06Q 30/00; G06Q 30/02

(52) U.S. Cl. 705/14.11; 705/1.1

(57) ABSTRACT

A method performed by at least one processing system includes detecting that a purchaser of an item with a trade-in option has performed an action corresponding to the trade-in option using the processing system and modifying a trade-in option level of the purchaser using the processing system based on the action.

### BACKGROUND

The introduction of new items (i.e., products and services) in a market represents an opportunity for sellers to increase demand by acquiring new customers and enticing existing customers to replace older items. Once a seller has the business of a customer, the seller often seeks ways to maintain the customer relationship so that the customer will continue to purchase items from the seller. The seller may also try to avoid losing customers to competitors.

### BRIEF DESCRIPTION OF THE DRAWINGS

FIG. 1 is a block diagram illustrating one embodiment of a trade-in option processing environment that provides trade-in option levels of items that depend on the actions of purchasers.

FIGS. 2A-2B are flowcharts illustrating embodiments of methods for modifying trade-in levels based on the actions of a purchaser.

FIG. 3 is a block diagram illustrating a processing system configured to implement a trade-in option processing environment.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a trade-in option processing environment allows a seller to provide trade-in level upgrades to purchasers of items with trade-in options based on the actions of purchasers. By doing so, the seller can reward customers who take actions that are in the interest of the seller. The trade-in option processing environment tracks activity of the purchaser and modifies a trade-in option level of the purchaser based on a set of trade-in rules. When a purchaser trades in an item, the environment determines a trade-in value for the purchaser from the trade-in option level.

The trade-in option processing environment may allow a seller to boost customer loyalty and spread demand over time, thereby reducing the customer's costs of timing her or his purchase poorly (e.g., by purchasing an item before a newer, improved version is released). The environment may be particularly applicable in markets where item replacement is induced by technology advancements (e.g., consumer electronics and automobiles) or fashion trends (e.g., haute couture and prêt-a-porter clothing).

As used herein, the term “trade-in”, when used as a noun, refers to at least one item transferred from a purchaser to a seller as part of an exchange for at least one other item. The term “trade-in”, when used as a verb, refers to exchanging at least one item from a purchaser in return for at least one other item from a seller. The term “trade-in option” refers to a financial contract (i.e., a financial asset) sold by a seller to a purchaser for a price where the contract specifies terms and conditions of a set of transactions related to a trade-in value. In some embodiments, the price of a trade-in option may be zero. The term “trade-in option level” refers to a subset of the terms and conditions of a trade-in option that correspond to a set of activities defined by the seller and performed by a purchaser. The term “trade-in value” refers to the consideration, expressed in any suitable form such as a monetary value or a discount percentage on a new purchase, that a seller provides a purchaser for a trade-in.

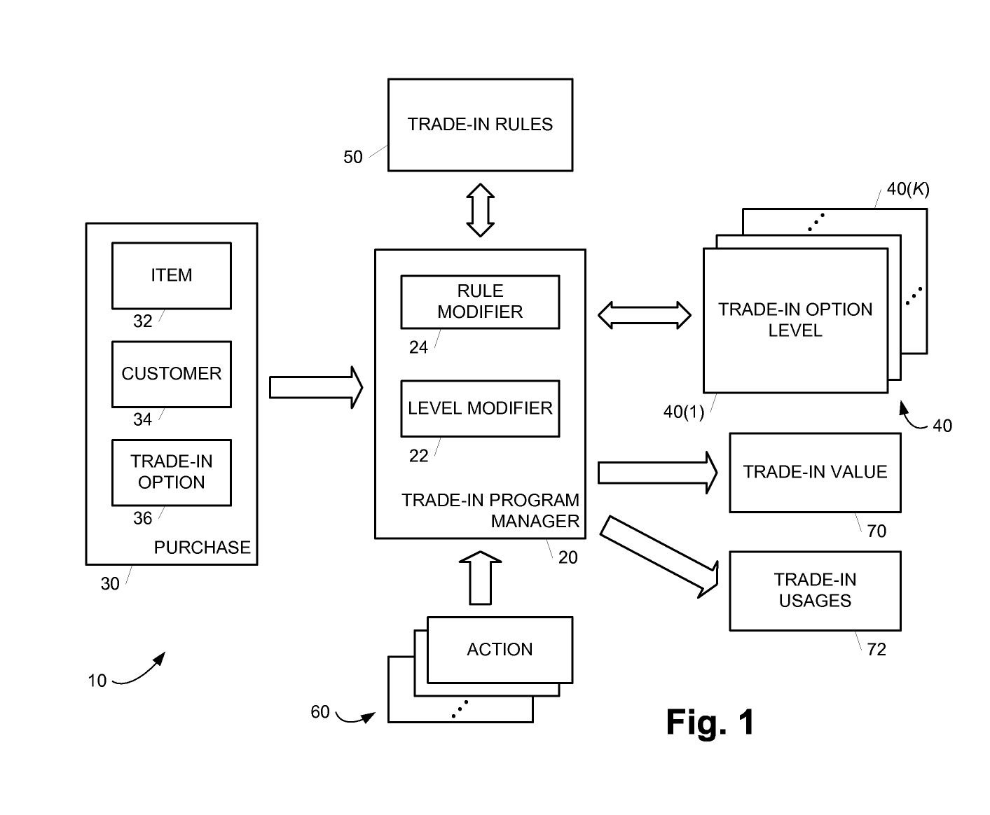

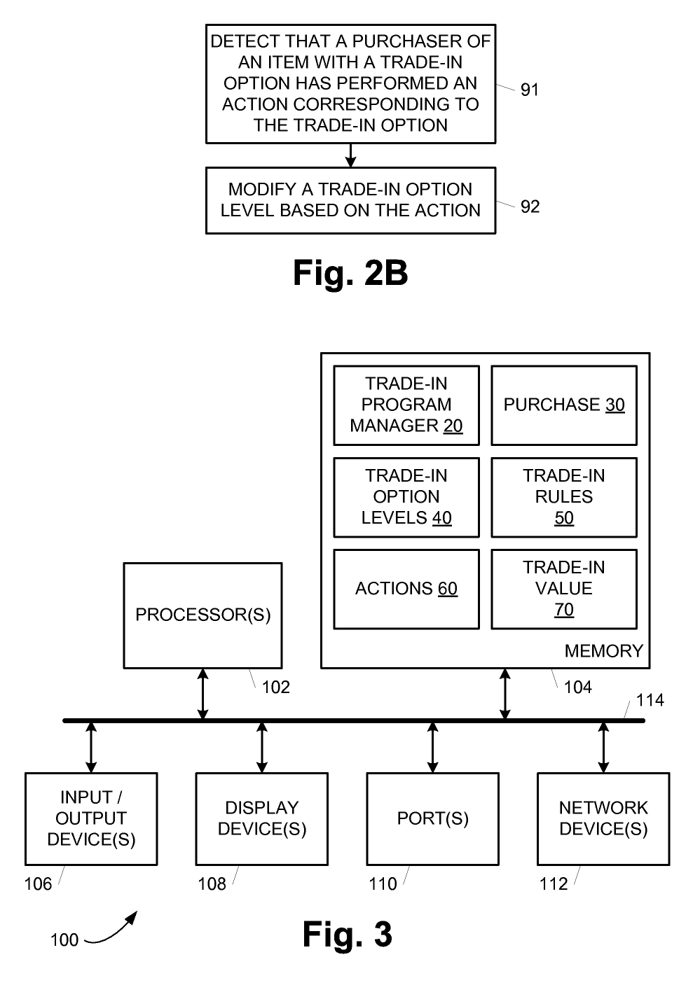

FIG. 1 is a block diagram illustrating one embodiment of a trade-in option processing environment 10 that provides trade-in option levels 40 of items, where the trade-in option levels 40 depend on the actions of purchasers. Environment 10 includes a trade-in program manager 20 that processes purchase information 30, trade-in rules 50, and actions 60 of purchasers to determine trade-in option levels 40, and ultimately, trade-in values 70 and, in some embodiments, trade-in usages 72 for the purchasers. Environment 10 may be implemented using one or more processing systems (e.g., a processing system 100 shown in FIG. 3 and described in additional detail below).

Trade-in program manager 20 receives purchase information 30 that includes item information 32 that identifies an item purchased by a purchaser, customer information 34 that identifies the purchaser, and trade-in option information 36 that identifies a trade-in option for the purchased item. The trade-in option may be sold as bundled with an item by the seller or may be purchased by the purchaser for value in addition to the cost of the item. In addition, the trade-in option may be provided by the seller at the time of the purchase of an item or may be purchased separately by the purchaser before or after the purchase of the item.

Because it is a financial asset with price and a value (i.e., a trade-in value), trade-in program manager 20 may be used to create a market for trade-in options to allow the trade-in options to be bought and sold. In particular, trade-in program manager 20 may provide a purchaser with the ability to sell a trade-in option to another customer of a seller. Trade-in program manager 20 captures transaction information related to exchanges of trade-in options in the market to provide a seller with additional insights into the behavior and interests of customers.

From trade-in option information 36, trade-in program manager 20 identifies an initial trade-in option level 40 from a set of trade-in option levels 40(1)-40(K), where K is an integer that is greater than or equal to two. As used herein, the term trade-in option level 40 refers to an individual one of the set of trade-in option levels 40(1)-40(K), and the term trade-in option levels 40 refers to the set of trade-in option levels 40(1)-40(K) collectively. Each trade-in option level 40 defines a trade-in value of the set of items.

Subsequent to identifying an initial trade-in option level 40, trade-in program manager 20, with the permission and/or cooperation of the purchaser, monitors actions 60 of the purchaser that correspond to trade-in option 40. Actions 60 include any suitable behavior of the purchaser that is defined by the seller and detectable by trade-in program manager 20. Examples of actions 60 performed by a purchaser include purchasing an additional item or service from the seller or an affiliate of the seller, referring a customer to the seller or an affiliate of the seller, and recommending or otherwise promoting the seller or an item of the seller on a social network or other suitable electronic forum (e.g., a website). Actions 60 may be detected by trade-in program manager 20 in any suitable way including verifying any proof of completion of an action 60 that is provided by the purchaser. When an action 60 is detected by trade-in program manager 20, trade-in program manager 20 accesses a set of trade-in rules 50 defined by the seller to determine whether action 60, in conjunction with any other previously detected actions 60 by the purchaser, qualifies the purchaser for an trade-in option level upgrade. If so, trade-in program manager 20 modifies the trade-in option level 40 of the purchaser so that the purchaser is now identified with the upgraded trade-in option level 40(1)-40(K).

An upgrade in the trade-in option level 40 corresponds to more favorable trade-in option conditions for the purchaser (e.g., higher trade-in values, fewer restrictions on the usage of the trade-in values, extension of the trade-in option applicability to other items currently owned by the purchaser, extension of the trade-in option expiration time, or transferability of the trade-in option to other customers in the customer base of the seller).

As an example, if a purchaser buys an extended warranty with an item associated with trade-in option 36, then the purchaser may be upgraded to a “perfect status” trade-in option level 40 at any time regardless of the actual condition of the item. As another example, a purchaser who buys software applications from the seller's partner software providers may be entitled to an increased trade-in level, which in turn entitles the purchaser to a higher trade-in value relative to a baseline percentage, depending on the number of applications or total price of applications purchased.

When the purchaser trades-in the item, trade-in program manager 20 determines trade-in value 70 from the current trade-in option level 40 and, in some embodiments, also determines trade-in usages 72 from the current trade-in option level 40. Trade-in usages 72 identify how that the trade-in value may be used by the purchaser. Trade-in usages 72 may include the ability of the purchaser to use a portion of trade-in value 70 as a discount towards another item offered by the seller. For example, trade-in usages 72 may inform the purchaser of the ability to use part of the trade-in value for a 10% discount on another item.

Trade-in program manager 20 may also provide a user interface (not shown) to a seller to allow the seller to define and/or modify the set of rules 50 for each item offered by the seller.

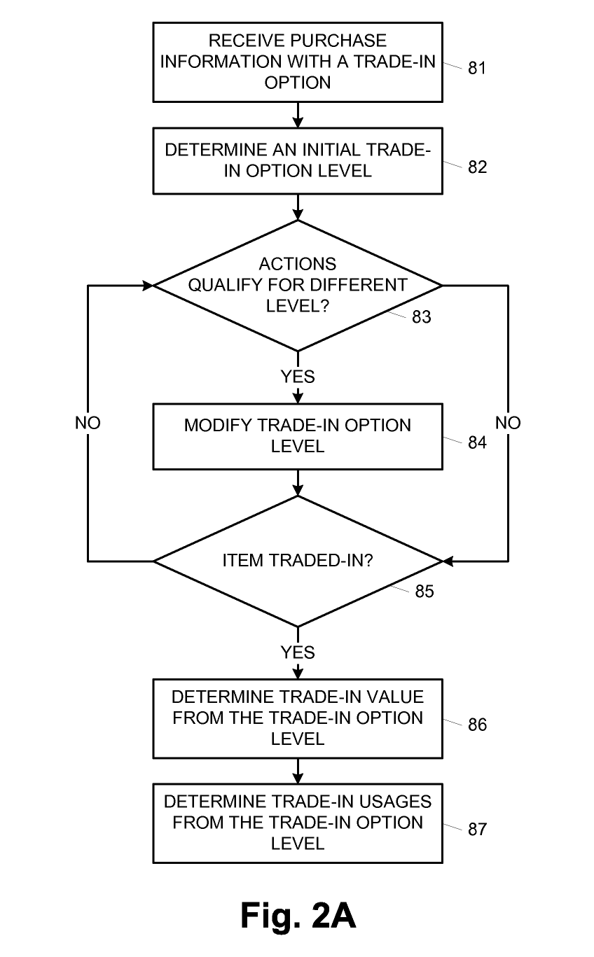

FIGS. 2A-2B are flowcharts illustrating embodiments of methods for modifying trade-in levels based on the actions of a purchaser. The methods of FIGS. 2A-2B will be described with respect to trade-in program manager 20 (shown in FIG. 1) according to one embodiment.

In the embodiment of FIG. 2A, trade-in program manager 20 receives purchase information 30 with trade-in option 36 as indicated in a block 81. Trade-in program manager 20 determines an initial trade-in option level 40 from trade-in option 36 as indicated in a block 82. On determining the initial trade-in option level 40, trade-in program manager 20 may provide the purchaser with detailed information regarding the initial trade-in option level 40 (e.g., by email) along with details regarding actions 60 that the purchaser may take to upgrade the initial trade-in option level 40.

Trade-in program manager 20 determines whether actions 60 of a purchaser qualify the purchaser for a different trade-in option level 40 as indicated in a block 83. Trade-in program manager 20 accesses trade-in rules 50 and compares the set of actions 60 performed by the purchaser to trade-in rules 50 to determine whether the purchaser qualifies for a different trade-in option level 40 (i.e., an upgraded level or a downgraded level). If so, trade-in program manager 20 modifies the trade-in option level 40 in accordance with trade-in rules 50 as indicated in a block 84 to associate the new trade-in option level 40 with the purchaser. Each time that trade-in program manager 20 modifies the trade-in option level 40, trade-in program manager 20 may provide the purchaser with detailed information regarding the updated trade-in option level 40 (e.g., by email) along with details regarding additional actions 60 that the purchaser may take to further upgrade the trade-in option level 40.

Trade-in program manager 20 determines whether the purchaser traded-in the item as indicated in a block 85. Trade-in program manager 20 may detect that a purchaser of an item with a trade-in option is trading in an item in response to receiving a communication from the purchaser or another processing system (e.g., a purchasing system of the seller). When the purchaser trades-in the item, trade-in program manager 20 determines trade-in value 70 from the current trade-in option level 40 as indicated in a block 86. In addition, trade-in program manager 20 determines trade-in usages 72 from the current trade-in option level 40 as indicated in a block 87.

By providing a purchaser with an ability to modify a trade-in option level 40, trade-in program manager 20 provides purchasers who do perform actions 60 with a final trade-in value 70 that may differ from an initial trade-in value of trade-in option 36. In particular, trade-in program manager 20 may provide such purchasers with a final trade-in value 70 that exceeds the initial trade-in value.

In the embodiment of FIG. 2B, trade-in program manager 20 detects that a purchaser of an item with a trade-in option has performed an action 60 corresponding to the trade-in option as indicated in a block 91. Trade-in program manager 20 modifies the trade-in option level 40 based on the action 60 as indicated in a block 92.

FIG. 3 is a block diagram illustrating a processing system 100 configured to implement a trade-in option processing environment 10 (shown in FIG. 1) to provide trade-in option levels 40 of items that depend on the actions 60 of purchasers.

Processing system 100 includes at least one processor 102 configured to execute machine readable instructions stored in a memory system 104. Processing system 100 may also include any suitable number of input/output devices 106, display devices 108, ports 110, and/or network devices 112. Processors 102, memory system 104, input/output devices 106, display devices 108, ports 110, and network devices 112 communicate using a set of interconnections 114 that includes any suitable type, number, and/or configuration of controllers, buses, interfaces, and/or other wired or wireless connections. Components of processing system 100 (for example, processors 102, memory system 104, input/output devices 106, display devices 108, ports 110, network devices 112, and interconnections 112) may be contained in a common housing (not shown) or in any suitable number of separate housings (not shown).

Processing system 100 may execute a basic input output system (BIOS), firmware, an operating system, a runtime execution environment, and/or other services and/or applications stored in memory 104 (not shown) that includes machine readable instructions that are executable by processors 102 to manage the components of processing system 100 and provide a set of functions that allow other programs (e.g., contract analysis unit 40) to access and use the components.

Processing system 100 represents any suitable processing device, or portion of a processing device, configured to implement the functions of contract analysis unit 40 as described above. A processing device may be a laptop computer, a tablet computer, a desktop computer, a server, or another suitable type of computer system. A processing device may also be a mobile telephone with processing capabilities (i.e., a smart phone), a digital still and/or video camera, a personal digital assistant (PDA), an audio/video device, or another suitable type of electronic device with processing capabilities. Processing capabilities refer to the ability of a device to execute instructions stored in a memory 104 with at least one processor 102.

Each processor 102 is configured to access and execute instructions stored in memory system 104. Each processor 102 may execute the instructions in conjunction with or in response to information received from input/output devices 106, display devices 108, ports 110, and/or network devices 112. Each processor 102 is also configured to access and store data in memory system 104.

Memory system 104 includes any suitable type, number, and configuration of volatile or non-volatile storage devices configured to store instructions and data. The storage devices of memory system 104 represent computer readable storage media that store computer-readable and computer-executable instructions including contract analysis unit 40. Memory system 104 stores instructions and data received from processors 102, input/output devices 106, display devices 108, ports 110, and network devices 112. Memory system 104 provides stored instructions and data to processors 102, input/output devices 106, display devices 108, ports 110, and network devices 112. The instructions are executable by processing system 100 to perform the functions and methods of trade-in program manager 20 described herein. Memory system 104 stores trade-in program manager 20, purchase information 30, trade-in option levels 40, trade-in rules 50, actions 60, and trade-in value 70. Examples of storage devices in memory system 104 include hard disk drives, random access memory (RAM), read only memory (ROM), flash memory drives and cards, and other suitable types of magnetic and/or optical disks.

Input/output devices 106 include any suitable type, number, and configuration of input/output devices configured to input instructions and/or data from a user to processing system 100 and output instructions and/or data from processing system 100 to the user. Examples of input/output devices 106 include a touchscreen, buttons, dials, knobs, switches, a keyboard, a mouse, and a touchpad.

Display devices 108 include any suitable type, number, and configuration of display devices configured to output image, textual, and/or graphical information to a user of processing system 100. Examples of display devices 108 include a display screen, a monitor, and a projector.

Ports 110 include suitable type, number, and configuration of ports configured to input instructions and/or data from another device (not shown) to processing system 100 and output instructions and/or data from processing system 100 to another device.

Network devices 112 include any suitable type, number, and/or configuration of network devices configured to allow processing system 100 to communicate across one or more wired or wireless networks (not shown). Network devices 112 may operate according to any suitable networking protocol and/or configuration to allow information to be transmitted by processing system 100 to a network or received by processing system 112 from a network.

The above embodiments may advantageously allow a seller to exploit cross-selling opportunities in a customer base. Given the dynamic nature of the embodiments, the embodiments may provide the seller with the ability to influence the set of purchaser actions in a strategic way (e.g. to improve sales of specific items), track loyal customers reaction to different promotions (e.g. changes in the rules for level upgrades), detect trends quickly, and, as a result, adapt the company strategies to the needs and expectations of the customer base.

From the customer's point of view, an advantageous trade-in program enriched with level upgrades provides the customer with some measure of control over the issue of timing item purchases well. In markets with high item replacement rate (due to frequent technology improvements or fashion trends), customers effectively offer loyalty in exchange for favorable purchase conditions.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A method performed by at least one processing system, the method comprising:
detecting that a purchaser of an item with a trade-in option has performed an action corresponding to the trade-in option using the processing system; and
modifying a trade-in option level of the purchaser based on the action using the processing system.

2. The method of claim 1 further comprising:
determining a trade-in value from the trade-in option level using the processing system in response to the purchaser trading in the item.

3. The method of claim 2 further comprising:
determining a trade-in usage from the trade-in option level using the processing system in response to the purchaser trading in the item.

4. The method of claim 3 wherein the trade-in usage includes an ability of the purchaser to use a portion of the trade-in value as a discount towards another item.

5. The method of claim 1 further comprising:
modifying the trade-in option level includes upgrading the trade-in option level based on the action.

6. The method of claim 1 further comprising:
modifying the trade-in option level in accordance with a set of trade-in rules.

7. The method of claim 1 further comprising:
providing the trade-in option with the item in response to the purchaser purchasing of the item.

8. The method of claim 7 further comprising:
providing the trade-in option with the item in response to the purchaser purchasing of the item and the trade-in option.

9. The method of claim 1 wherein the action is at least one of purchasing an additional item, referring a customer, or recommending the item.

10. The method of claim 1 further comprising:
providing the purchaser with an ability to sell the trade-in option.

11. A computer-readable storage medium storing instructions that, when executed by a processing system, perform a method comprising:
detecting that a purchaser of an item with a trade-in option is trading in the item; and
providing a final trade-in value to the purchaser based on the trade-in option that differs from an initial trade-in value of the trade-in option based on a set of actions performed by the purchaser subsequent to purchasing the item.

12. The computer-readable storage medium of claim 11, wherein the final trade-in value exceeds the initial trade-in value.

13. The computer-readable storage medium of claim 11, wherein the set of actions include at least one of purchasing an additional item, referring a customer, or recommending the item.

14. A method performed by at least one processing system, the method comprising:
detecting that a purchaser of an item with a trade-in option has performed an action corresponding to the trade-in option using the processing system;
accessing a set of trade-in rules corresponding to the trade-in option using the processing system; and
upgrading a trade-in option level of the purchaser in accordance with the set of trade-in rules using the processing system.

15. The method of claim 14 further comprising:
determining a trade-in value from the trade-in option level using the processing system in response to the purchaser trading in the item.
